(19) United States
(12) Patent Application Publication
(10) Pub. No.: US 2015/0114204 A1
(43) Pub. Date: Apr. 30, 2015

(54) CONTAINER MARACA CONVERTER

(71) Applicant: Romain Emmanuel Lochen, Congenies (FR)

(72) Inventor: Romain Emmanuel Lochen, Congenies (FR)

(21) Appl. No.: 14/068,089

(22) Filed: Oct. 31, 2013

(51) Int. Cl. G10D 13/06

(52) U.S. Cl. CPC G10D 13/06
USPC 84/402; 29/896.22

(57) ABSTRACT

A container maraca converter that allows a container, particularly a previously-used beverage can, to be converted into a maraca or similar noisemaker. A plurality of small noisemakers, general small ball-shaped objects, may be placed in the container. A handle and container attachment is then attached to the container, both closing the container and allowing for easy grip in the hand. Upon shaking, the noisemakers rattle within the can to produce the desired sound effect. After use, the device may be easily broken down for disposal and/or recycling of its parts

### TECHNICAL FIELD

The invention relates to sound-making instruments and noisemakers, particularly to a hand-shaken maraca or maraca-like instrument.

### BACKGROUND OF THE INVENTION

Maracas (sometimes called rumba shakers) are simple percussion instruments (idiophones), usually played in pairs, traditionally made from a dried gourd shell filled with seeds or dried beans. Maracas are classically made from the fruit of the higuera tree that is very common in warm and tropical climates. The fruit must be round and small. After taking out the pulp of the fruit through holes that are bored through the dried shell, small pebbles are introduced into it. Then a handle is fitted to the dry fruit shell. Unequal amount of pebbles are used in a pair that make up the maracas, to produce their distinctive sound.

More modern designs, of course, exist and these may also be made of leather, wood, or plastic. Often one maraca is pitched high and the other low. Many historians believe that the instrument is of prehistoric origin in the greater Americas; and that the word maraca is thought to have come from the Tupi language of Brazil. Maracas are heard in many forms of Latin American music and are also used in pop and classical music. They are considered characteristic of the music of Colombia, Venezuela, and Brazil.

In current times, maracas or maraca-like devices have been increasingly used as noisemakers for entertainment, celebration and sporting events. Unlike the complex and time-consuming traditional way of making maracas, current demand exists for a quickly-made, inexpensive, and in the end, possibly disposable and/or recyclable maraca.

### SUMMARY OF THE INVENTION

Numerous variations, modifications, alternatives, and alterations of the various preferred embodiments, processes, and methods may be used alone or in combination with one another as will become more readily apparent to those with skill in the art, with reference to the following detailed description of the preferred embodiments and the accompanying figures and drawings.

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations.

Advantages of the method of the specification include quickly and easily making a maraca or maraca-like instrument with simple and inexpensive materials, including the possible recycling of certain materials into new forms. A handle is attachable to a container, in particular an empty beverage container, and with the addition of suitable noisemakers to the container, make an inexpensive and simple device.

### BRIEF DESCRIPTION OF THE DRAWINGS

Without limiting the scope of the Method for making and using a Container Maraca Converter as claimed below and referring now to the drawings and figures, all shown not-to-scale:

FIG. 1 shows an elevated perspective view of an embodiment of the present invention;

FIG. 2 shows a front elevation view of the embodiment of FIG. 1;

FIG. 2A shows a cross section view of the embodiment of FIG. 2, taken along line 2A-2A;

FIG. 3 shows a side view of the embodiment of FIG. 1;

FIG. 4 shows a top plan view of the embodiment of FIG. 1;

FIG. 5 shows a bottom plan view of the embodiment of FIG. 1;

FIG. 6 shows an embodiment of one part of the present invention;

FIG. 7 shows another top plan view of an embodiment of the present invention;

FIG. 8 shows a detail of an embodiment consistent with FIG. 7, taken along line 8-8;

FIG. 9 shows a detail of another embodiment consistent with FIG. 7, taken along line 8-8;

FIG. 10 shows a detail of another embodiment consistent with FIG. 7, taken along line 8-8;

FIG. 11 shows a detail of another embodiment consistent with FIG. 7, taken along line 8-8;

FIG. 12 shows an exploded view of a plan view of one part of an embodiment of the present invention along with a cross section view of another part of the present invention;

FIG. 13 shows an assembled view of a plan view of one part of an embodiment of the present invention along with a cross section view of another part of the present invention; and

FIG. 14 shows an embodiment of the present invention, attached to a container, with auxiliary noisemaker inserts present in the container.

These drawings are provided to assist in the understanding of the exemplary embodiments of the device as described in more detail below and should not be construed as unduly limiting the device. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

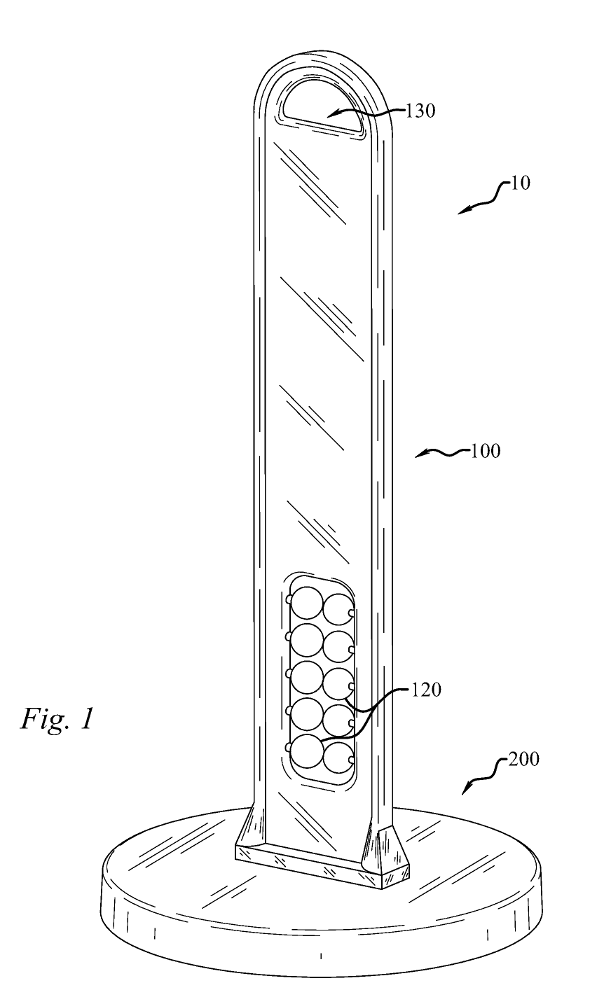

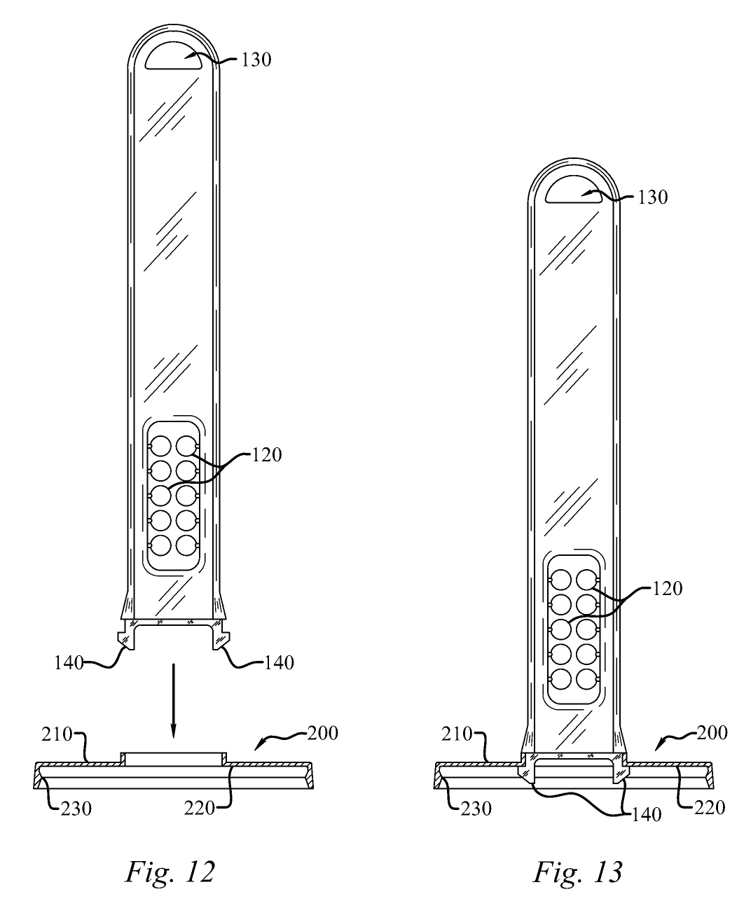

The container maraca converter as depicted in some embodiments, by way of illustration and not limitation in FIGS. 1-14, discloses certain embodiments, by way of example only, of multi-form embodiments of a container maraca converter.

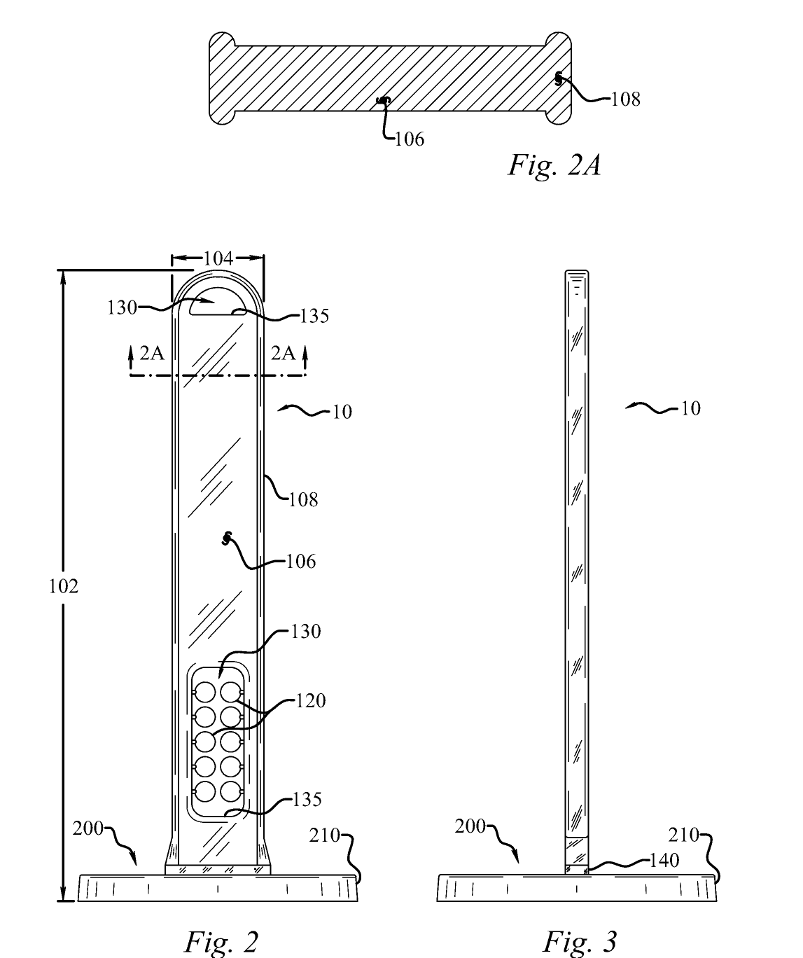

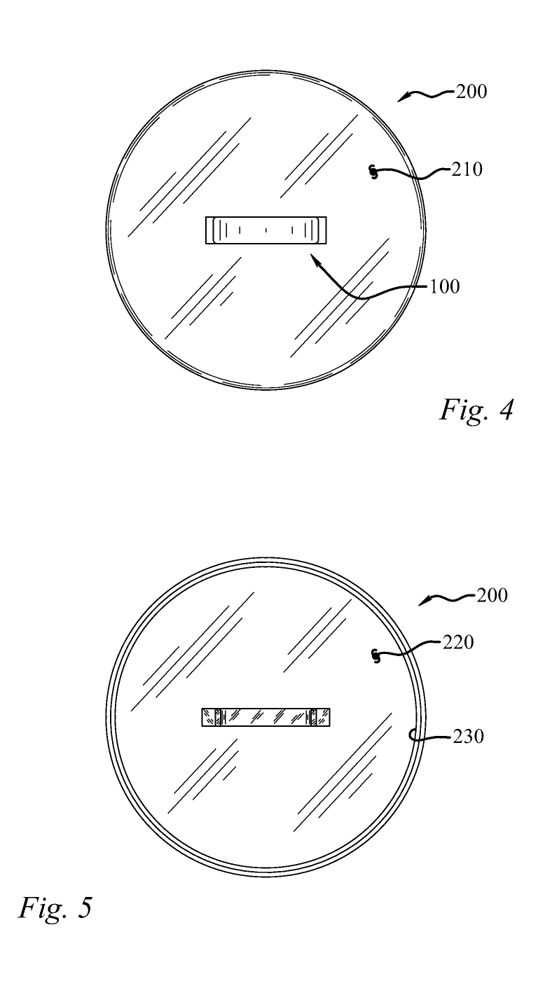

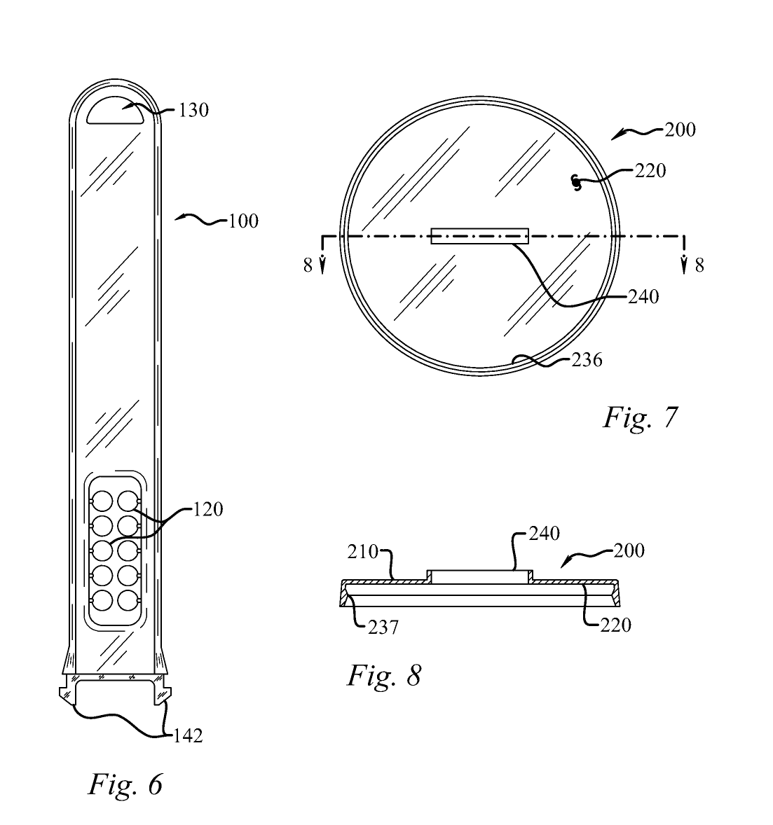

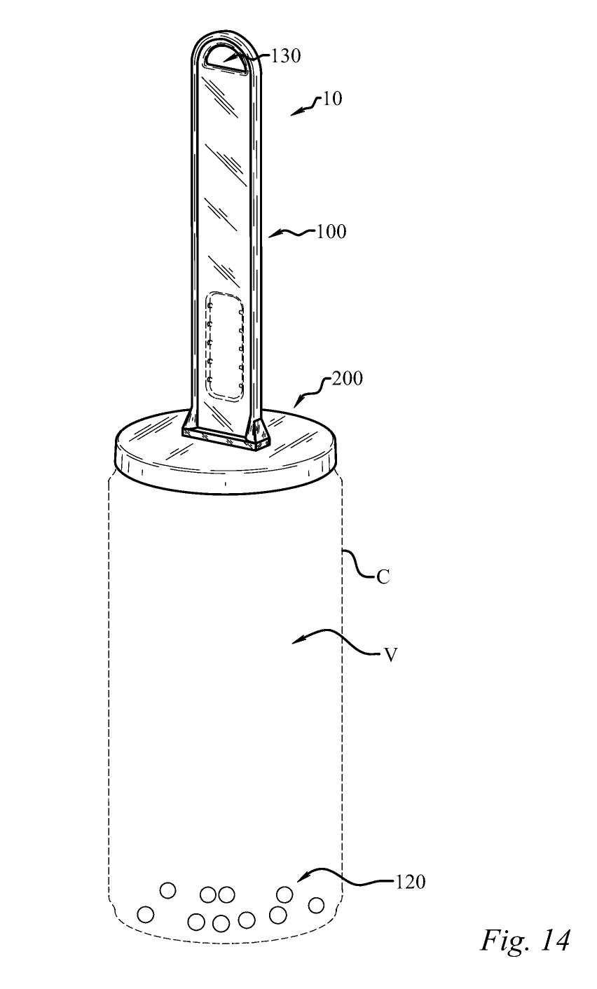

In a preferred embodiment, as seen in FIGS. 1, 2, and 14, a container maraca converter (10) may include a handle (100) having a handle length (102), a handle width (104) and at least an area of handle first thickness (106), all as seen in FIGS. 2 and 2A. There may be a handle-interface attachment means (140), as seen well in FIGS. 3 and 6. The container maraca converter (10) may attach to a container (C) having a container volume (V) as seen in FIG. 14, by means of a handle-container interface (200) having an interface-handle surface (210), an interface-handle attachment means (240), and where an interface-container surface (220) with a container attachment means (230) makes the attachment to the container (C), as seen well in FIGS. 4, 5, and 7.

The handle-interface attachment means (140) cooperates with the interface-handle attachment means (240) to couple the handle (100) to the handle-container interface (200). The noisemaking aspects of the present invention are enabled by a plurality of auxiliary noisemaker inserts (120) that may be placed in the container volume (V), as seen in FIG. 14.

The handle (100) may be provided with many different levels of stiffness, to facilitate the container maraca converter (10) being shaken in the human hand. As one skilled in the art would know, the relative stiffness of the handle (100) may be controlled by a number of means, such as making the entire handle (100) from a relatively more stiff material as opposed to a relatively less stiff material; or by making the handle (100) either thicker (more stiff) or thinner (less stiff). One method, intended by way of example and not limitation, is providing areas of different thickness in the handle (100), that is, by having at least an area of handle second thickness (108) present as well as the area of handle first thickness (106), an arrangement seen well in FIGS. 2 and 2A. Such areas of differential thickness may provide stiffness without adding a great deal of weight.

The handle (100) may have at least one handle fenestration (130) having a fenestration edge (135). In some embodiments, auxiliary noisemaker inserts (120) are detachably molded to the fenestration edge (135), seen well in FIGS. 1, 2, and 6. These noisemakers may be detached, before use, from the container maraca converter (10) and placed in a prior art container (C), as seen in FIG. 14, to provide noise when the container (C) is shaken. The auxiliary noisemaker inserts (120) may be detachably molded at some other place on the handle (100) or to the handle-container interface (200), or as would be known to one skilled in the art, could be supplied not attached to, and in totally separately from the container maraca converter (10). In fact, the auxiliary noisemaker inserts (120) need not be made of the same materials as the container maraca converter (10), the handle (100), or the handle-container interface (200). By way of example only, the handle (100) and handle-container interface (200) may be made of a more flexible material, while the auxiliary noisemaker inserts (120) may be made from a relatively harder material.

In one embodiment, the cooperation of the handle-interface attachment means (140) and the interface-handle attachment means (240) releasably couples the handle (100) to the handle-container interface (200), as seen well in FIGS. 6, 7, 12, and 13. In a preferred embodiment, the handle-interface attachment means (140) is a snap-fit attachment means (142), as seen in FIG. 6. However, any means of attaching the handle (100) and the handle-container interface (200) is expressly intended by this specification, including those embodiments where the handle (100) and the handle-container interface (200) are fixedly attached, as by welding or similar means, and also those embodiments where the handle (100) and the handle-container interface (200) are formed of a single uniform piece. In such an embodiment, the handle-interface attachment means (140) and the interface-handle attachment means (240) are simply the point of merger of the handle (100) and the handle-container interface (200). In those embodiments where the handle (100) and the handle-container interface (200) may be supplied as pieces requiring joining by the user, the pieces may be supplied independently as seen in FIGS. 6 and 8, or where the handle (100) is detachably molded to the handle-container interface (200). In the latter case, the handle (100) and the handle-container interface (200) could first be separated, as for example when they are detachably molded together, and then assembled near the time of use by the user.

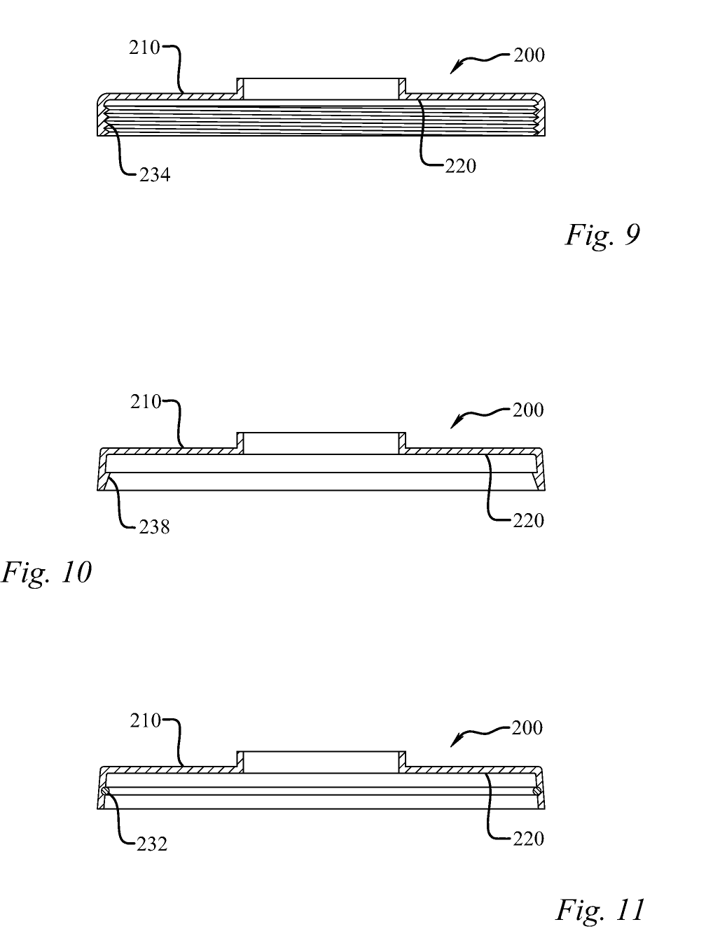

Numerous methods may be used for the container attachment means (230) to attach the container maraca converter (10) to a container (C), and all are contemplated herein. In one embodiment, seen in FIG. 11, the container attachment means (230) may be a snap ring attachment means (232). In other embodiments, as seen in FIG. 9, the container attachment means (230) is a threaded attachment means (232). In a preferred embodiment, as seen in FIGS. 8 and 10, the container attachment means (230) may be a snap fitment (232) formed integrally with the container attachment means (230). Such a snap fitment (232) may be sized and formed, by way of example and not limitation, to use the inherent resilience of a plastic material forming the container maraca converter (10) to stretch over, and thereby snap on, the rolled top edge seen in many popular beverage cans. The snap fitment (232) may be formed integrally with the container attachment means (230) as a snap-fit band (237), seen well in FIG. 8, as well as in other specific embodiments, where the snap fitment (232) may be at least one hook fastener (238), as seen in FIG. 10.

Various methods may be used to assemble the container maraca converter (10) in those embodiments where it may be supplied to the user as more than one piece. For example one method of assembling a container maraca converter (10) would include the steps of first attaching a handle (100) to a handle-container interface (200) by attaching a handle-interface attachment means (140) on the handle (100) to an interface-handle attachment means (240) on the handle-container interface (200). Next, a user would place a plurality of auxiliary noisemaker inserts (120) within a container (C) having an open container volume (V). The container maraca converter (10) would then be readied for use by attaching the handle-container interface (200) to the container (C) to simultaneously connect the handle (100) to the container (C) and close the container volume (V). Vigorous shaking of the container maraca converter (10) would then produce the desired sounds. In a preferred embodiment, where the auxiliary noisemaker inserts (120) are supplied to the user molded to a section of the device, such as being initially molded to the handle (100) and/or the handle-container interface (200), the step of placing the plurality of auxiliary noisemaker inserts (120) within a container (C) having an open container volume (V) would follow the detachment of the auxiliary noisemaker inserts (120) from their as-molded positions.

Numerous alterations, modifications, and variations of the preferred embodiments disclosed herein will be apparent to those skilled in the art and they are all anticipated and contemplated to be within the spirit and scope of the instant invention. Further, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims.

We claim:

1. A container maraca converter (10), comprising;
a handle (100) having a handle length (102), a handle width (104) and at least an area of handle first thickness (106), a handle-interface attachment means (140) and;
a handle-container interface (200) having an interface-handle surface (210), an interface-handle attachment means (240) and an interface-container surface (220) having a container attachment means (230);
wherein the handle-interface attachment means (140) cooperates with the interface-handle attachment means (240) to couple the handle (100) to the handle-container interface (200);
the container attachment means (230) couples the interface-container surface (220) to a container (C) having an internal volume (V); and
a plurality of auxiliary noisemaker inserts (120).

2. The device according to claim 1, wherein the at least an area of handle first thickness (106) further includes at least an area of handle second thickness (108).

3. The device according to claim 1, wherein the handle (100) has at least one handle fenestration (130) having a fenestration edge (135).

4. The device according to claim 1, wherein the cooperation of the handle-interface attachment means (140) and the interface-handle attachment means (240) releasably couples the handle (100) and the handle-container interface (200).

5. The device according to claim 3, wherein the auxiliary noisemaker inserts (120) are detachably molded to the fenestration edge (135).

6. The device according to claim 1, wherein the auxiliary noisemaker inserts (120) are detachably molded to the handle (100).

7. The device according to claim 1, wherein the auxiliary noisemaker inserts (120) are detachably molded to the handle-container interface (200).

8. The device according to claim 1, wherein the handle (100) is detachably molded to the handle-container interface (200).

9. The device according to claim 1, wherein the handle-interface attachment means (140) is a snap-fit attachment means (142).

10. The device according to claim 1, wherein the container attachment means (230) is a snap ring attachment means (232).

11. The device according to claim 1, wherein the container attachment means (230) is a threaded attachment means (232).

12. The device according to claim 1, wherein the container attachment means (230) is a snap fitment (232) formed integrally with the container attachment means (230).

13. The device according to claim 12, wherein the snap fitment (232) formed integrally with the container attachment means (230) is a snap-fit band (237).

14. The device according to claim 12, wherein the snap fitment (232) formed integrally with the container attachment means (230) is at least one hook fastener (238).

15. A method of assembling a container maraca converter (10) comprising the steps of:
1) attaching a handle (100) to a handle-container interface (200) by attaching a handle-interface attachment means (140) on the handle (100) to an interface-handle attachment means (240) on the handle-container interface (200);
2) placing a plurality of auxiliary noisemaker inserts (120) within a container (C) having an open container volume (V);
3) attaching the handle-container interface (200) to the container (C) to simultaneously connect the handle (100) to the container (C) and close the container volume (V).

16. The method according to claim 15, wherein the step of placing the plurality of auxiliary noisemaker inserts (120) within a container (C) having an open container volume (V) is preceded by a step of detaching a plurality of auxiliary noisemaker inserts (120) molded to a section of the container maraca converter (10) selected from the sections consisting of the handle (100) and the handle-container interface (200).

17. A container maraca converter (10), comprising;
a handle (100) having a handle length (102), a handle width (104) and at least an area of handle first thickness (106), a handle-interface attachment means (140) and;
a handle-container interface (200) having an interface-handle surface (210), an interface-handle attachment means (240) and an interface-container surface (220) having a container attachment means (230);
wherein the handle-interface attachment means (140) cooperates with the interface-handle attachment means (240) to couple the handle (100) to the handle-container interface (200);
the container attachment means (230) couples the interface-container surface (220) to a container (C) having an internal volume (V); and
a plurality of auxiliary noisemaker inserts (120) detachably molded to a section of the device selected from the sections consisting of the handle (100) and the handle-container interface (200).
